(19) United States
(12) Patent Application Publication
(10) Pub. No.: US 2020/0243901 A1
(43) Pub. Date: Jul. 30, 2020

(54) METHOD FOR PRODUCING SULFIDE-BASED SOLID ELECTROLYTE PARTICLES

(71) Applicant: TOYOTA JIDOSHA KABUSHIKI KAISHA, Toyota-shi (JP)

(72) Inventor: Yusuke KINTSU, Susono-shi (JP)

(73) Assignee: TOYOTA JIDOSHA KABUSHIKI KAISHA, Toyota-shi (JP)

(21) Appl. No.: 16/748,074

(22) Filed: Jan. 21, 2020

(30) Foreign Application Priority Data
Jan. 28, 2019 (JP) 2019-011904

(51) Int. Cl. H01M 10/0562; H01M 10/0525

(52) U.S. Cl. CPC H01M 10/0562; H01M 2300/0068; H01M 10/0525

(57) ABSTRACT

Provided is a method for producing sulfide-based solid electrolyte particles, which is configured to form the sulfide-based solid electrolyte particles into fine particles, while keeping the ion conductivity of the particles at a desired ion conductivity. Disclosed is a method for producing sulfide-based solid electrolyte particles, the method comprising: preparing a sulfide-based solid electrolyte material comprising lithium, phosphorus and sulfur; preparing a mixed solvent of a hydrocarbon-based compound and an ether-based compound; and forming the sulfide-based solid electrolyte material into fine particles by pulverizing the sulfide-based solid electrolyte material in the mixed solvent under an inert gas atmosphere, wherein a water concentration of the mixed solvent is 100 mass ppm or more and 200 mass ppm or less.

### TECHNICAL FIELD

The disclosure relates to a method for producing sulfide-based solid electrolyte particles.

### BACKGROUND

In recent years, with the rapid spread of IT and communication devices such as personal computers, camcorders and cellular phones, great importance has been attached to the development of batteries that is usable as the power source of such devices. In the automobile industry, etc., high-power and high-capacity batteries for electric vehicles and hybrid vehicles are under development.

Of all-solid-state batteries, an all-solid-state lithium ion battery has attracted attention, due to its high energy density resulting from the use of a battery reaction accompanied by lithium ion transfer, and due to the use of a solid electrolyte as the electrolyte present between the cathode and the anode, in place of a liquid electrolyte containing an organic solvent.

Patent Literature 1 discloses a method for manufacturing sulfide solid electrolyte microparticles having an average particle size of 0.1 μm to 10 μm, the method comprising pulverizing sulfide solid electrolyte coarse particles once in a non-aqueous solvent containing a dispersion stabilizer.

Patent Literature 2 discloses a method for producing a sulfide solid electrolyte material, the method comprising a microparticulating step of adding an ether compound to a coarse-grained material of a sulfide solid electrolyte material and microparticulating the coarse-grained material by a pulverization treatment.

Patent Literature 3 discloses a method for manufacturing an electrode composite, the method comprising: a first step for coating an active material mold with a liquid material including a solid electrolyte to form a solid electrolyte layer; a second step for heating the liquid material thus coated at a first temperature which allows removal of organic substances; and a third step for compounding the active material mold with the solid electrolyte layer by heating at a second temperature higher than the first temperature. Patent Literature 3 also discloses that the second and third steps are performed in the state of being pressurized to an atmospheric pressure or higher.

Patent Literature 4 discloses a method for manufacturing a solid electrolyte, the method comprising a crystallization process in which an amorphous solid electrolyte obtained by reacting lithium sulfide with at least one kind of compound selected from phosphorus sulfide, germanium sulfide, silicon sulfide, and boron sulfide is heated in a solvent and crystallized.

Patent Literature 5 discloses a method for synthesizing a sulfide-based, lithium ion-conducting solid electrolyte, the method comprising heating materials in an inert gas flow containing water to melt the solid electrolyte.

Patent Literature 1: Japanese Patent Application Laid-Open (JP-A) No. 2008-004459

Patent Literature 2: Patent No. JP5445527

Patent Literature 3: JP-A No. 2017-157288

Patent Literature 4: JP-A No. 2014-096391

Patent Literature 5: JP-A No. 1994-279050

A sulfide-based solid electrolyte is a soft material that is easily formed into particles concurrently with pulverization. Accordingly, it is difficult to form the sulfide-based solid electrolyte into fine particles. Meanwhile, a conventional dispersants is problematic in that it reacts with the sulfide-based solid electrolyte, deteriorates the sulfide-based solid electrolyte, and decreases the ion conductivity of the sulfide-based solid electrolyte.

### SUMMARY

In light of the above circumstances, an object of the disclosed embodiment is to provide a method for producing sulfide-based solid electrolyte particles, which is configured to form the sulfide-based solid electrolyte particles into fine particles, while keeping the ion conductivity of the particles at a desired ion conductivity.

In a first embodiment, there is provided a method for producing sulfide-based solid electrolyte particles,
the method comprising:
preparing a sulfide-based solid electrolyte material comprising lithium, phosphorus and sulfur;
preparing a mixed solvent of a hydrocarbon-based compound and an ether-based compound; and
forming the sulfide-based solid electrolyte material into fine particles by pulverizing the sulfide-based solid electrolyte material in the mixed solvent under an inert gas atmosphere,
wherein a water concentration of the mixed solvent is 100 mass ppm or more and 200 mass ppm or less.

According to the disclosed embodiment, a method for producing sulfide-based solid electrolyte particles, which is configured to form the sulfide-based solid electrolyte particles into fine particles, while keeping the ion conductivity of the particles at a desired ion conductivity, is provided.

### BRIEF DESCRIPTION OF THE DRAWING

FIG. 1 is a view showing the relationship between the water concentration of the mixed solvent, the average particle diameter of the sulfide-based solid electrolyte particles, and the Li ion conductivity of the sulfide-based solid electrolyte particles.

### DETAILED DESCRIPTION

The disclosed embodiment is a method for producing sulfide-based solid electrolyte particles,
the method comprising:
preparing a sulfide-based solid electrolyte material comprising lithium, phosphorus and sulfur;
preparing a mixed solvent of a hydrocarbon-based compound and an ether-based compound; and
forming the sulfide-based solid electrolyte material into fine particles by pulverizing the sulfide-based solid electrolyte material in the mixed solvent under an inert gas atmosphere,
wherein a water concentration of the mixed solvent is 100 mass ppm or more and 200 mass ppm or less.

For the production of a high-performance, all-solid-state battery comprising a sulfide-based solid electrolyte, pulverization of the sulfide-based solid electrolyte is necessary to increase the ion conductivity of the sulfide-based solid electrolyte.

However, since the ion conductivity of the sulfide-based solid electrolyte is decreased by reaction with water, it is needed to control the water concentration of a solvent that is mixed with the sulfide-based solid electrolyte at the time of pulverizing the sulfide-based solid electrolyte.

The type of the solvent that allows efficient pulverization of the sulfide-based solid electrolyte, while suppressing a decrease in the ion conductivity of the sulfide-based solid electrolyte, and the range of the water concentration of the solvent, were found.

The production method of the disclosed embodiment comprises at least (1) preparing the sulfide-based solid electrolyte material, (2) preparing the mixed solvent, and (3) forming the sulfide-based solid electrolyte material into fine particles.

Hereinafter, these steps will be described in order.

### (1) Preparing a Sulfide-Based Solid Electrolyte Material

This is a step of preparing a sulfide-based solid electrolyte material comprising lithium, phosphorus and sulfur.

In the disclosed embodiment, the sulfide-based solid electrolyte material is a material that is not yet formed into fine particles.

The main components of the sulfide-based solid electrolyte material are lithium, phosphorus and sulfur. This means that the total content of the lithium, phosphorus and sulfur in the sulfide-based solid electrolyte material is 50 mol % or more. The total content may be 60 mol % or more, or it may be 70 mol % or more.

As the sulfide-based solid electrolyte material, examples include, but are not limited to, materials that are used as sulfide-based solid electrolytes in all-solid-state batteries.

As the sulfide-based solid electrolyte, examples include, but are not limited to, Li₂S—P₂S₅, Li₂S—SiS₂, LiX—Li2S—SiS₂, LiX—Li₂S—P₂S₅, LiX—Li₂O—Li₂S—P₂S₅, LiX—Li₂S—P₂O₅, LiX—Li₃PO₄—P₂S₅ and Li₃PS₄. The “Li₂S—P₂S₅” means a material composed of a raw material composition containing Li₂S and P₂S₅, and the same applies to other solid electrolytes. Also, “X” in the “LiX” means a halogen element.

When the sulfide-based solid electrolyte is composed of a raw material composition containing LiX (where X is F, Cl, Br and/or I), the LiX may account for 1 mol % to 60 mol %, 5 mol % to 50 mol %, or 10 mol % to 40 mol % of the raw material composition, for example. In the disclosed embodiment, the X may be at least one selected from the group consisting of Cl, Br and I, or it may be Br and I. This is because the Li ion conductivity of the sulfide-based solid electrolyte particles can be further increased. When two or more kinds of LiX are contained in the raw material composition, the mixing ratio thereof is not particularly limited.

As the composition of the sulfide-based solid electrolyte, examples include, but are not limited to, 15LiBr-10LiI-75 (0.75Li₂S-0.25P₂S₅). The numerals shown in the composition mean a molar ratio.

The molar ratio of the elements in the sulfide-based solid electrolyte can be controlled by controlling the contents of the elements contained in raw materials. The molar ratio and composition of the elements in the sulfide-based solid electrolyte can be measured by inductively coupled plasma atomic emission spectroscopy, for example.

As the sulfide-based solid electrolyte, one or more kinds of sulfide-based solid electrolytes may be used. In the case of using two or more kinds of sulfide-based solid electrolytes, they may be mixed together.

The sulfide-based solid electrolyte may be a sulfide glass, a crystallized sulfide glass (a glass ceramics) or a crystalline material obtained by developing a solid state reaction of the raw material composition. From the viewpoint of efficiently forming the sulfide-based solid electrolyte into fine particles, the sulfide-based solid electrolyte may be a sulfide glass.

The crystal state of the sulfide-based solid electrolyte can be confirmed by X-ray powder diffraction measurement using CuKα radiation, for example.

The sulfide glass can be obtained by amorphizing a raw material composition (such as a mixture of Li₂S and P₂S₅). The raw material composition can be amorphized by mechanical milling, for example. The mechanical milling may be dry mechanical milling or wet mechanical milling. The mechanical milling may be the latter because attachment of the raw material composition to the inner surface of a container, etc., can be prevented.

The glass ceramics can be obtained by heating the sulfide glass, for example.

As the form of the sulfide-based solid electrolyte material, examples include, but are not limited to, a particulate form.

From the viewpoint of ease of handling, the average particle diameter (D50) of the sulfide-based solid electrolyte material may be in a range of from 5 μm to 200 μm, or it may be in a range of from 10 μm to 100 μm.

### (2) Preparing a Mixed Solvent

This is a step of preparing a mixed solvent of a hydrocarbon-based compound and an ether-based compound.

The water concentration of the mixed solvent may be 100 mass ppm or more and 200 mass ppm or less.

The method for controlling the water concentration of the mixed solvent in a range of from 100 mass ppm to 200 mass ppm, is not particularly limited. For example, the water concentration can be controlled by adding an adsorbent to the mixed solvent or by distilling the mixed solvent. As the mixed solvent, a commercially-available mixed solvent having a water concentration in the above range, may be used.

The hydrocarbon-based compound is not particularly limited, as long as it is a material that can disperse the sulfide-based solid electrolyte material without deterioration. As the hydrocarbon-based compound, examples include, but are not limited to, aromatic hydrocarbons such as alkane (e.g., heptane, hexane and octane), benzene, toluene and xylene.

The ether-based compound is not particularly limited, as long as it is a material that can disperse the sulfide-based solid electrolyte material without deterioration. For example, the ether-based compound may be an ether-based compound having 2 to 20 carbon atoms. From the viewpoint of ease of handling, the ether-based compound may be di-n-butyl ether.

The percentage (mass ratio) of the hydrocarbon-based compound and ether-based compound contained in the mixed solvent is not particularly limited. When the total mass of the mixed solvent is determined as 100 mass %, the hydrocarbon-based compound contained in the mixed solvent may be from 60 mass % to 90 mass %, and the ether-based compound contained in the mixed solvent may be from 10 mass % to 40 mass %.

The ether-based compound functions as an accelerator of pulverization of the sulfide-based solid electrolyte material. As the percentage of the ether-based compound contained in the mixed solvent increases, the sulfide-based solid electrolyte material can be pulverized finer. However, if the percentage of the ether-based compound contained in the mixed solvent is more than 40 mass %, there is a possibility that the sulfide-based solid electrolyte material reacts with the ether-based compound to deteriorate the sulfide-based solid electrolyte material.

### (3) Forming the Sulfide-Based Solid Electrolyte Material Into Fine Particles

This is a step of forming the sulfide-based solid electrolyte material into fine particles by pulverizing the sulfide-based solid electrolyte material in the mixed solvent under an inert gas atmosphere.

In this step, a dispersion in which the sulfide-based solid electrolyte material is dispersed in the mixed solvent, may be produced and then pulverized.

In this step, the sulfide-based solid electrolyte material is subjected to wet pulverization by use of the mixed solvent. Accordingly, the formation of the sulfide-based solid electrolyte material into particles at the time of pulverization, and the attachment of the sulfide-based solid electrolyte material to the inner surface of a container, etc., are suppressed.

The method for pulverizing the sulfide-based solid electrolyte material is not particularly limited, as long as it is a method by which the sulfide-based solid electrolyte material can be formed into fine particles of a desired size. As the pulverizing method, examples include, but are not limited to, wet mechanical milling with a tumbling mill, a vibrating mill, a bead mill, a planetary ball mill, or the like.

As the inert gas, examples include, but are not limited to, nitrogen gas and argon gas.

For example, in the case of using a planetary ball mill, the pulverizing condition may be as follows: the sulfide-based solid electrolyte material, the mixed solvent and grinding balls are put in the container of the planetary ball mill; the atmosphere inside the container is substituted with an inert gas atmosphere; and the sulfide-based solid electrolyte material is pulverized by operating the planetary ball mill at a predetermined rotational frequency for a predetermined time.

The ball diameter (φ) of the grinding balls may be in a range of from 0.05 mm to 2 mm, or it may be in a range of from 0.3 mm to 1 mm, for example. The reason is as follows. If the ball diameter is too small, it is difficult to handle the grinding balls, and the grinding balls may lead to contamination. If the ball diameter is too large, it may be difficult to pulverize the sulfide-based solid electrolyte material into particles with a desired particle diameter.

Also in the case of using the planetary ball mill, the plate rotational frequency may be in a range of from 100 rpm to 400 rpm, or it may be in a range of from 150 rpm to 300 rpm, for example. If the plate rotational frequency is less than 100 rpm, it may be difficult to pulverize the sulfide-based solid electrolyte material into particles with a desired particle diameter. If the plate rotational frequency is more than 400 rpm, there is a possibility that the sulfide-based solid electrolyte material is pulverized too much, and the resulting sulfide-based solid electrolyte particles aggregate.

Also in the case of using the planetary ball mill, the pulverizing time may be in a range of from 0.5 hour to 15 hours, or it may be in a range of from one hour to 10 hours.

In the pulverization, the amount of the sulfide-based solid electrolyte material added to the mixed solvent is not particularly limited. From the viewpoint of efficiently forming the sulfide-based solid electrolyte material into fine particles, the amount of the sulfide-based solid electrolyte material may be from 10 parts by mass to 30 parts by mass, or it may be from 10 parts by mass to 25 parts by mass, with respect to 100 parts by mass of the mixed solvent.

For the average particle diameter of the sulfide-based solid electrolyte particles obtained by this step, the upper limit may be 0.500 μm or less, or it may be 0.376 μm or less, from the viewpoint of increasing the ion conductivity of the sulfide-based solid electrolyte particles. The lower limit is not particularly limited. From the viewpoint of ease of production, the lower limit may be 0.100 μm or more, or it may be 0.206 μm or more.

In the disclosed embodiment, unless otherwise noted, the average particle diameter of particles is a volume-based median diameter (D₅₀) measured by laser diffraction/scattering particle size distribution measurement. Also in the disclosed embodiment, the median diameter (D₅₀) of particles is a diameter at which, when particles are arranged in ascending order of their particle diameter, the accumulated volume of the particles is half (50%) the total volume of the particles (volume average diameter).

### [All-Solid-State Battery]

From the viewpoint of increasing the performance of an all-solid-state battery, the sulfide-based solid electrolyte particles obtained by the production method of the disclosed embodiment, may be used as a material for forming at least one selected from the group consisting of the cathode, anode and solid electrolyte layer of the all-solid-state battery.

As the all-solid-state battery, examples include, but are not limited to, an all-solid-state lithium battery in which a lithium metal deposition-dissolution reaction is used as an anode reaction, an all-solid-state lithium ion battery in which lithium ions transfer between the cathode and the anode, an all-solid-state sodium battery, an all-solid-state magnesium battery and an all-solid-state calcium battery. The all-solid-state battery may be an all-solid-state lithium ion battery. Also, the all-solid-state battery may be a primary or secondary battery.

### EXAMPLES

### Example 1

In an Ar atmosphere, 40 g of ZrO₂ balls (φ 0.3 mm), 2 g of a sulfide-based solid electrolyte material (15LiBr-10LiI-75 (0.75Li₂S-0.25P₂S₅), 5 g of heptane, and 3 g of di-n-butyl ether were put in a 50 cm³ zirconia pot, thereby obtaining a dispersion. The zirconia pot was hermetically closed to ensure that the atmosphere inside the zirconia pot was an Ar atmosphere.

Before putting the materials in the zirconia pot, the heptane (5 g) and di-n-butyl ether (3 g) were mixed to obtain a mixed solvent. The water concentration of the mixed solvent were measured by a Karl Fischer water content meter (“AQ-300” manufactured by Hiranuma Sangyo Co., Ltd.) As a result, the water concentration was found to be 100 mass ppm.

Then, the zirconia pot was installed in a planetary ball mill (“P-7” manufactured by FRITSCH). The sulfide-based solid electrolyte material in the pot was pulverized by wet mechanical milling at a plate rotational frequency of 200 rpm for 10 hours, thereby obtaining a slurry.

Then, the slurry was dried on a hot plate at 120° C. for 3 hours, thereby obtaining pulverized sulfide-based solid electrolyte particles. The average particle diameter (D₅₀) of the particles was measured by a laser diffraction particle size distribution analyzer (“MICROTRAC II” manufactured by MicrotracBEL Corp.) As a result, the average particle diameter (D₅₀) was found to be 0.376 μm.

The thus-obtained sulfide-based solid electrolyte particles were heated on a hot plate at 200° C. for 3 hours. The heated sulfide-based solid electrolyte particles was pressed, thereby producing a pellet having an area of 1 cm² and a thickness of about 0.5 mm. The Li ion conductivity of the sulfide-based solid electrolyte particles was calculated by AC impedance measurement of the pellet.

The AC impedance measurement was carried out by use of “SOLARTRON 1260” at an applied voltage of 5 mV and in a measured frequency range of from 0.01 MHz to 1 MHz. The resistance value of the pellet at 100 kHz was obtained by the AC impedance measurement. The resistance value was corrected based on the thickness of the pellet, and the resulting value was converted into the Li ion conductivity of the sulfide-based solid electrolyte particles.

For Example 1, the Li ion conductivity ratio based on Example 2 (Li ion conductivity of Example 1/Li ion conductivity of Example 2) was calculated. As a result, the ratio was found to be 0.955.

### Example 2

The sulfide-based solid electrolyte particles of Example 2 were produced in the same manner as Example 1, except that the water concentration of the mixed solvent of the heptane and the di-n-butyl ether was 150 mass ppm. For the sulfide-based solid electrolyte particles, the average particle diameter (D₅₀) was 0.359 μm, and the Li ion conductivity ratio based on Example 2 (Li ion conductivity of Example 2/Li ion conductivity of Example 2) was 1.000.

### Example 3

The sulfide-based solid electrolyte particles of Example 3 were produced in the same manner as Example 1, except that the water concentration of the mixed solvent of the heptane and the di-n-butyl ether was 200 mass ppm. For the sulfide-based solid electrolyte particles, the average particle diameter (D₅₀) was 0.206 μm, and the Li ion conductivity ratio based on Example 2 (Li ion conductivity of Example 3/Li ion conductivity of Example 2) was 0.974.

### Comparative Example 1

The sulfide-based solid electrolyte particles of Comparative Example 1 were produced in the same manner as Example 1, except that the water concentration of the mixed solvent of the heptane and the di-n-butyl ether was 75 mass ppm. For the sulfide-based solid electrolyte particles, the average particle diameter (D₅₀) was 0.578 μm, and the Li ion conductivity ratio based on Example 2 (Li ion conductivity of Comparative Example 1/Li ion conductivity of Example 2) was 0.965.

### Comparative Example 2

The sulfide-based solid electrolyte particles of Comparative Example 2 were produced in the same manner as Example 1, except that the water concentration of the mixed solvent of the heptane and the di-n-butyl ether was 250 mass ppm. For the sulfide-based solid electrolyte particles, the average particle diameter (D₅₀) was 0.212 μm, and the Li ion conductivity ratio based on Example 2 (Li ion conductivity of Comparative Example 2/Li ion conductivity of Example 2) was 0.929.

### Comparative Example 3

The sulfide-based solid electrolyte particles of Comparative Example 3 were produced in the same manner as Example 1, except that the water concentration of the mixed solvent of the heptane and the di-n-butyl ether was 350 mass ppm. For the sulfide-based solid electrolyte particles, the average particle diameter (D₅₀) was 0.225 μm, and the Li ion conductivity ratio based on Example 2 (Li ion conductivity of Comparative Example 3/Li ion conductivity of Example 2) was 0.922.

### Comparative Example 4

The sulfide-based solid electrolyte particles of Comparative Example 4 were produced in the same manner as Example 1, except that the water concentration of the mixed solvent of the heptane and di-n-butyl ether was 500 mass ppm. For the sulfide-based solid electrolyte particles, the average particle diameter (D₅₀) was 0.244 μm, and the Li ion conductivity ratio based on Example 2 (Li ion conductivity of Comparative Example 4/Li ion conductivity of Example 2) was 0.903.

TABLE 1

| | Water | Li ion | Average |
|---|---|---|---|
| | concentration | conductivity ratio | particle |
| | (mass ppm) | based on | diameter |
| | of mixed solvent | Example 2 | (μm) |
| Example 1 | 100 | 0.955 | 0.376 |
| Example 2 | 150 | 1.000 | 0.359 |
| Example 3 | 200 | 0.974 | 0.206 |
| Comparative Example 1 | 75 | 0.965 | 0.578 |
| Comparative Example 2 | 250 | 0.929 | 0.212 |
| Comparative Example 3 | 350 | 0.922 | 0.225 |
| Comparative Example 4 | 500 | 0.903 | 0.244 |

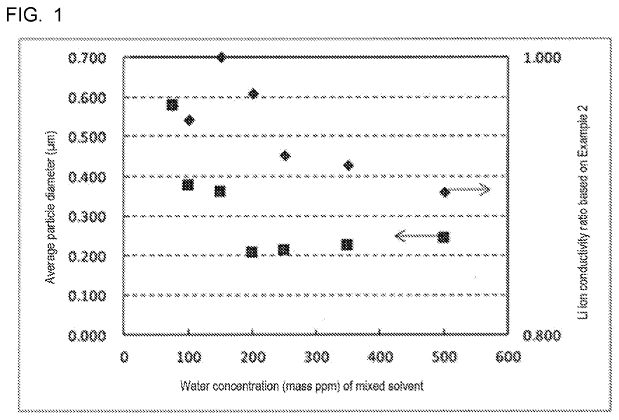

FIG. 1 is a view showing the relationship between the water concentration of the mixed solvent, the average particle diameter of the sulfide-based solid electrolyte particles, and the Li ion conductivity of the sulfide-based solid electrolyte particles. Squares shown in FIG. 1 indicate the average particle diameters of Examples 1 to 3 and Comparative Examples 1 to 4, and diamonds shown in FIG. 1 indicate the ion conductivities thereof.

As shown in FIG. 1, for the sulfide-based solid electrolyte particles that the water concentration of the mixed solvent was 75 mass ppm, the Li ion conductivity ratio based on Example 2 was 0.965 and high; however, the average particle diameter was 0.578 μm and large.

For the sulfide-based solid electrolyte particles that the water concentration of the mixed solvent was from 100 mass ppm to 200 mass ppm, it was found that the average particle diameter was 0.376 μm or less and small, while the Li ion conductivity ratio based on Example 2 was kept at 0.955 or more.

For the sulfide-based solid electrolyte particles that the water concentration of the mixed solvent was 250 mass ppm or more, it was found that while the average particle diameter was small, the Li ion conductivity was low, and the desired Li ion conductivity was not obtained.

As a result, the following was revealed. Water is highly reactive with the sulfide-based solid electrolyte and easily deteriorates the sulfide-based solid electrolyte. However, due to the high reactivity, water is highly dispersible. Accordingly, due to the presence of a certain amount of water in the mixed solvent, water is effective in promoting the dispersion of the sulfide-based solid electrolyte, while suppressing the deterioration of the sulfide-based solid electrolyte.

When the water concentration of the mixed solvent was 250 mass ppm or more, the sulfide-based solid electrolyte particles did not obtain the desired Li ion conductivity. Accordingly, the deterioration reaction of the sulfide-based solid electrolyte particles is thought to gradually proceed.

1. A method for producing sulfide-based solid electrolyte particles,
the method comprising:
preparing a sulfide-based solid electrolyte material comprising lithium, phosphorus and sulfur;
preparing a mixed solvent of a hydrocarbon-based compound and an ether-based compound; and
forming the sulfide-based solid electrolyte material into fine particles by pulverizing the sulfide-based solid electrolyte material in the mixed solvent under an inert gas atmosphere,
wherein a water concentration of the mixed solvent is 100 mass ppm or more and 200 mass ppm or less.
